(19) United States
(12) Patent Application Publication
(10) Pub. No.: US 2015/0091880 A1
(43) Pub. Date: Apr. 2, 2015

(54) TOUCH INPUT DEVICE AND ELECTRONIC DEVICE HAVING THE SAME

(71) Applicant: Samsung Electronics Co., Ltd., Gyeonggi-do (KR)

(72) Inventor: Sungho Lee, Gyeongsangbuk-do (KR)

(21) Appl. No.: 14/500,676

(22) Filed: Sep. 29, 2014

(30) Foreign Application Priority Data
Sep. 27, 2013 (KR) 10-2013-0114863

(51) Int. Cl. G06F 3/0354

(52) U.S. Cl. CPC G06F 3/03545
USPC 345/179

(57) ABSTRACT

A stylus pen for a touch screen device includes a body to be hand-held by a user, and at least one protrusion formed on the body, wherein the stylus pen is stopped by the at least one protrusion contacting at least one stopper formed in a receiving hole of the touch screen device when the stylus pen is pushed into the receiving hole. An electronic device includes a main body having a touch screen, wherein the main body comprises a receiving hole having at least one stopper on its inside surface, and a stylus pen comprising a pen body to be hand-held by a user, and at least one protrusion formed on the pen body, wherein the stylus pen is stopped by the at least one protrusion contacting at least one stopper formed in the receiving hole of the touch screen device.

### CROSS-REFERENCE TO RELATED APPLICATION(S) AND CLAIM OF PRIORITY

The present application is related to and claims the benefit under 35 U.S.C. §119(a) of a Korean patent application No. 10-2013-0114863 filed on Sep. 27, 2013 in the Korean Intellectual Property Office and, the entire disclosure of which is hereby incorporated by reference.

### TECHNICAL FIELD

The present disclosure relates to a touch input device and an electronic device having the same, and more particularly, to a touch input device and an electronic device having the same that prevent erroneous insertion when inserting the touch input device into the electronic device and that enhance a grip feeling when holding the touch input device.

### BACKGROUND

A “mobile terminal” of a common concept is an electronic device that can perform wireless communication with another party while a user carries. Such a mobile terminal has developed to have a small size, small thickness, grip form, and light weight in consideration of portability and has developed to a multimedia device that can perform various functions.

Particularly, a future mobile terminal will be gradually developed to have a small size and a light weight, and to perform a multifunction and a multipurpose and to apply to various multimedia environments or Internet environments.

Further, a conventional mobile terminal has been changed to a structure that can communicate data in a high speed in addition to an audio dedicated communication function. That is, as a consumer desire increases, a service of the mobile terminal will be provided using wireless communication technology that transmits data in a high speed.

A general mobile terminal essentially includes a data input and output device, speaker device, microphone device, antenna device. Nowadays, in a mobile terminal such as a smart phone and an electronic pad, a touch pad or a touch screen is generally employed as a data input device.

As an auxiliary device that manipulates such a touch pad or touch screen, a touch input device, for example a touch pen of a writing instrument shape is housed within a mobile terminal body or a removable type touch pen to be separated separately from a mobile terminal is employed.

According to a structure of a touch input device and an electronic device having the same, when inserting the touch input device into the electronic device, erroneous insertion may be repeated and thus the touch input device and the electronic device may be damaged.

### SUMMARY

A stylus pen for a touch screen device includes a body to be hand-held by a user, and at least one protrusion formed on the body, wherein the stylus pen is stopped by the at least one protrusion contacting at least one stopper formed in a receiving hole of the touch screen device when the stylus pen is pushed into the receiving hole.

In some embodiments, the body comprises a first part having a pointer and a second part, and the at least one protrusion is formed on the second part of the body.

In some embodiments, the at least one protrusion is formed on at least a portion of an outer edge circumference of the second part of the body.

In some embodiments, a cross-section of the body substantially forms a polygon, and at least one protrusion is formed on at least one corner of the polygon on the second part of the body.

In some embodiments, the body comprises a first part and a second part and the body has a groove between the first part and the second part.

In some embodiments, the receiving hole of the touch screen device has a tongue on its inside surface, to engage the groove of the stylus pen.

In some embodiments, a cross-section of the body substantially forms a triangular, and at least one protrusion is formed on at least one corner of the triangular.

In some embodiments, a cross-section of the body substantially forms a rectangular, and at least one protrusion is formed on at least one corner of the rectangular.

In some embodiments, a cross section of the body is substantially an oval and at least one protrusion is formed on a circumference of the oval.

In some embodiments, the at least one protrusion is formed on the second part by forming a sectional area of the first part to be smaller than that of the second part.

An electronic device includes a main body having a touch screen, wherein the main body comprises a receiving hole having at least one stopper on its inside surface, and a stylus pen comprising a pen body to be hand-held by a user, and at least one protrusion formed on the pen body, wherein the stylus pen is stopped by the at least one protrusion contacting at least one stopper formed in the receiving hole of the touch screen device when the stylus pen is pushed into the receiving hole.

To address the above-discussed deficiencies, it is a primary object to provide a touch input device and an electronic device having the same that can prevent erroneous insertion when inserting the touch input device into the electronic device.

The present disclosure further provides a touch input device that enhances a user's grip feeling.

In accordance with an aspect of the present disclosure, a touch input device includes: a touch input unit, and a body extended from one end of the touch input unit, wherein the body includes a protrusion formed at a location facing the touch input unit.

In accordance with another aspect of the present disclosure, an electronic device includes a main body, a touch input device including a touch input unit and a body extended from one end of the touch input unit, wherein the body includes a protrusion formed at a location facing the touch input unit; and a pen receiving hole formed to correspond to a cross-section of the body from a surface to the inside of the main body.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a mobile terminal having a touch pen;

FIGS. 2A to 2C are front views of a touch pen, facing a pen point;

FIGS. 3A and 3B are cross-sectional views and a partial perspective view illustrating a touch input device according to an exemplary embodiment of the present disclosure;

FIGS. 4A and 4B are partial perspective views and a front view illustrating the touch input device of FIGS. 3A and 3B;

FIG. 5 is a perspective view illustrating an entire structure of the touch input device of FIGS. 3A and 3B;

FIGS. 6A and 6B are cross-sectional views and partial perspective views illustrating a touch input device according to various exemplary embodiments of the present disclosure;

FIGS. 7A and 7B are cross-sectional views and partial perspective views illustrating a touch input device according to various exemplary embodiments of the present disclosure;

FIGS. 8A and 8B are cross-sectional views and partial perspective views illustrating a touch input device according to various exemplary embodiments of the present disclosure;

FIG. 9 is a partial perspective view illustrating a touch input device according to another exemplary embodiment of the present disclosure; and

FIG. 10 is a perspective view illustrating a touch input device and an electronic device having the same according to an exemplary embodiment of the present disclosure.

### DETAILED DESCRIPTION

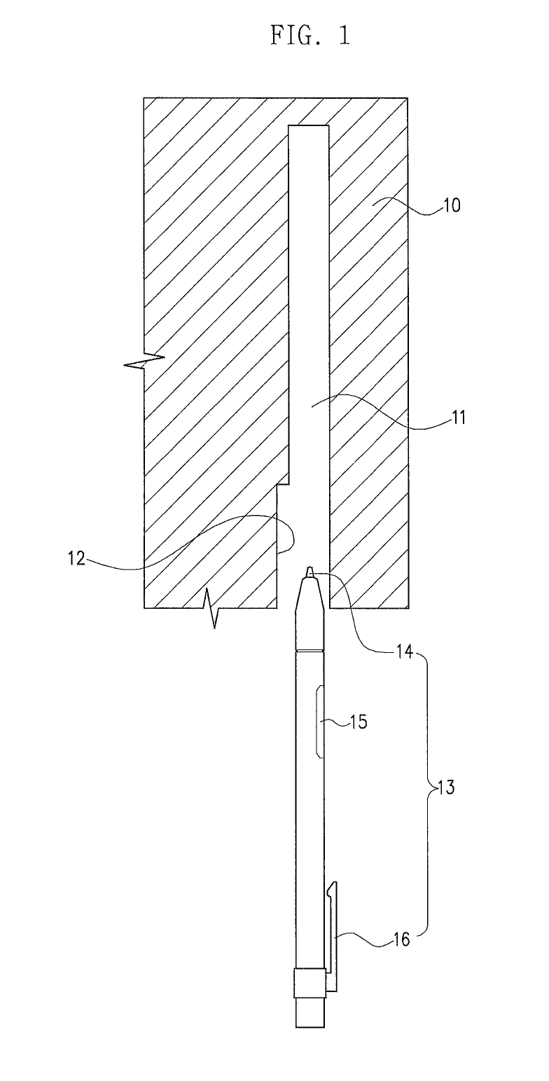

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Hereinafter, exemplary embodiments of the present disclosure are described in detail with reference to the accompanying drawings. The same reference numbers are used throughout the drawings to refer to the same or like parts. The views in the drawings are schematic views only, and are not intended to be to scale or correctly proportioned. Detailed descriptions of well-known functions and structures incorporated herein may be omitted to avoid obscuring the subject matter of the present disclosure.

In an exemplary embodiment of the present disclosure, an electronic device may be an entire information and communication device and a multimedia device such as a tablet Personal Computer (PC), mobile communication terminal, mobile phone, Personal Digital Assistant (PDA), smart phone, International Mobile Telecommunication 2000 (IMT-2000) terminal, Code Division Multiple Access (CDMA) terminal, Wideband Code Division Multiple Access (WCDMA) terminal, Global System for Mobile communication (GSM) terminal, General Packet Radio Service (GPRS) terminal, Enhanced Data GSM Environment (EDGE) terminal, Universal Mobile Telecommunication Service (UMTS) terminal, Digital Broadcasting terminal, and Automated Teller Machine (ATM) and an application thereof as a mobile terminal device.

The present disclosure relates to an electronic device having a touch input device and a terminal body, and in the terminal body, a pen receiving hole that receives a touch input device from a surface to the inside may be formed.

Hereinafter, as an exemplary embodiment of a touch input device, a touch pen is illustrated, but the touch input device is not limited thereto.

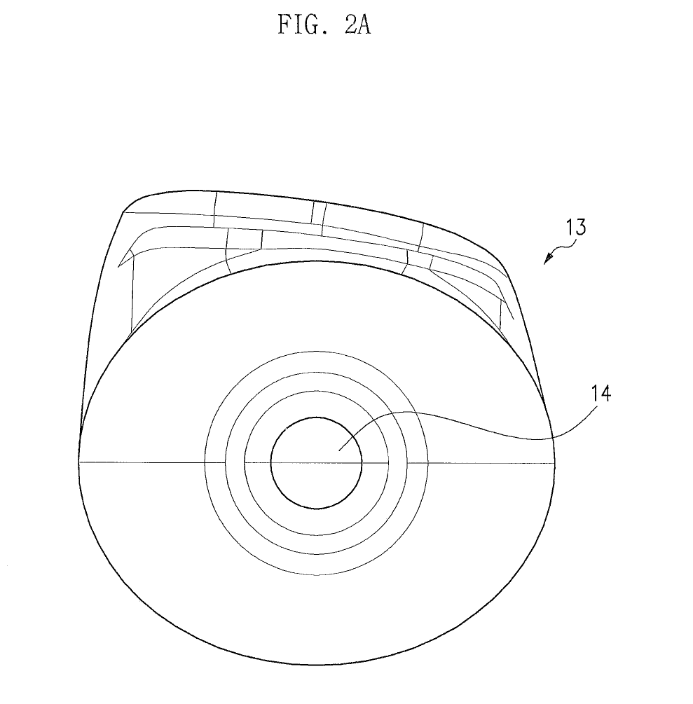

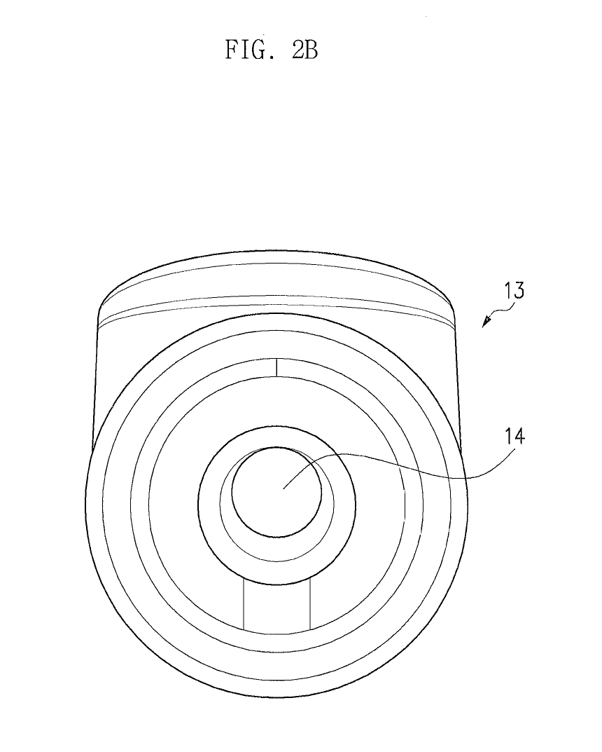

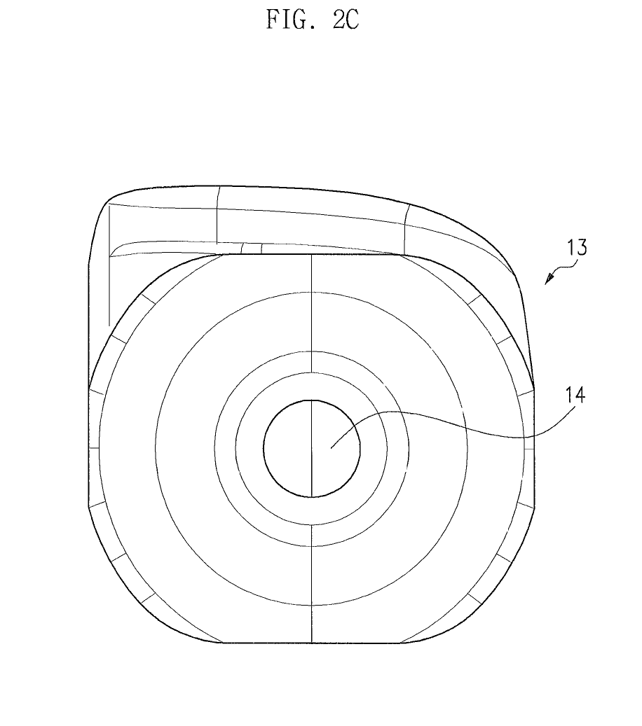

An example touch pen and a mobile terminal having the touch pen are described with reference to FIGS. 1 and 2A to 2C. FIG. 1 is a diagram illustrating a mobile terminal having a touch pen, and FIGS. 2A to 2C are front views illustrating a touch pen to face a pen point.

Referring to FIGS. 1 and 2A to 2C, a mobile terminal device 10 can include a pen receiving hole 11 where a touch pen 13 is inserted into or withdrawn from. The pen receiving hole 11 has at least one stopper on its inside surface.

The touch pen 13 can include a pen point 14 contacting on a touch screen or a touch pad, a penholder 15 corresponding to an area in which the user holds the touch pen 13 when using the touch pen 13, and a pen clip 16 protruded from one end of the penholder 15.

The built-in touch pen 13 of the mobile terminal 10 can be withdrawn from the pen receiving hole 11 provided in the mobile terminal 10 or can be inserted into the pen receiving hole 11.

As a body of the touch pen 13 is generally formed in a cylindrical shape, an outer edge circumference of the pen point 14 can be formed in a circle, oval, or polygon.

That is, a cross-section of an outer edge circumference of the touch pen 13 can be formed in one of symmetrical figures including an oval of FIG. 2A, a circle of FIG. 2B, and a polygon of FIG. 2C.

In order to receive the touch pen 13, a cross-section of an inner wall circumference of the pen receiving hole 11 can be formed to correspond to a shape of a cross-section of the touch pen 13 according to a shape of a cross-section of the touch pen 13. That is, a cross-section of the pen receiving hole 11 exposed at a surface of the mobile terminal 10 can be formed in one of symmetrical figures including a circle, oval, triangle, and polygon of a symmetrical structure.

For example, the touch pen 13 can have a side button to control operation thereof in an intermediate portion thereof or can have the pen clip 16 in an end portion thereof, i.e., components for several functions can be mounted at the touch pen 13.

In order to mount such components in the touch pen 13, a surface of the penholder 15 can be protruded, and as a function and component of the touch pen 13 increase, a surface of the touch pen 13 can be inevitably protruded.

A structure of such a touch pen 13 and pen receiving hole 11 has the following features. Because an outer edge circumference of a periphery of the pen point 14 has a symmetrical shape, when the user inserts the touch pen 13 into the pen receiving hole 11, it is difficult for the user to estimate a direction to insert the touch pen 13. Also, because a cross-section of an inner wall circumference of the pen receiving hole 11 as well as the touch pen 13 has a symmetrical shape, it is difficult to estimate a right direction to insert the touch pen 13 into the pen receiving hole 11. That is, in a state in which the user does not recognize a right direction, the touch pen 13 can be inserted into the pen receiving hole 11.

Thereby, when the user inserts the touch pen 13 into the pen receiving hole 11, even if the pen point 14 is first inserted, erroneous insertion in which a protruded portion of an intermediate portion or an end portion of the touch pen 13 is not inserted into a hole 12 that should be inserted can occur.

As described above, when erroneous insertion occurs, until the touch pen 13 is appropriately inserted, operation of withdrawing the touch pen 13 from the pen receiving hole 11 or operation of inserting the touch pen 13 into the pen receiving hole 11 should be repeated.

Therefore, a structure of the foregoing touch pen 13 and a mobile terminal device having the same can cause inconvenience when the user uses. Further, when erroneous insertion of the touch pen 13 is repeated, the pen receiving hole 11 and the touch pen 13 can be scratched, damaged, or lost.

Therefore, a touch pen and a mobile terminal device having the same that can recognize a right insertion direction when the user inserts the touch pen 13 into the pen receiving hole 11a and that provide an enhanced grip feeling when the user holds the touch pen 13 are requested.

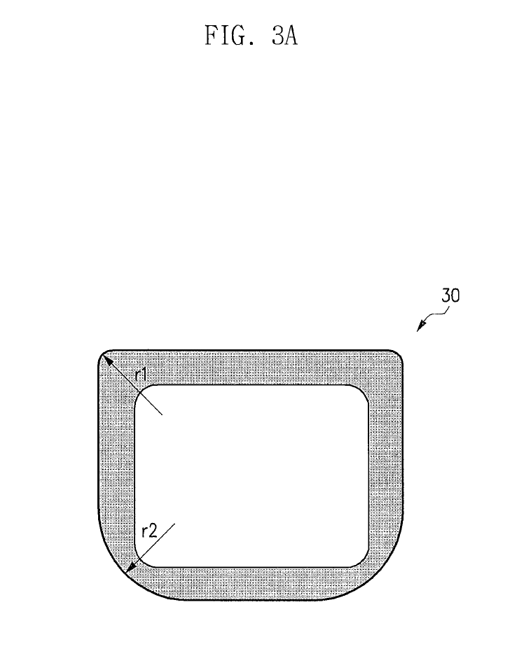

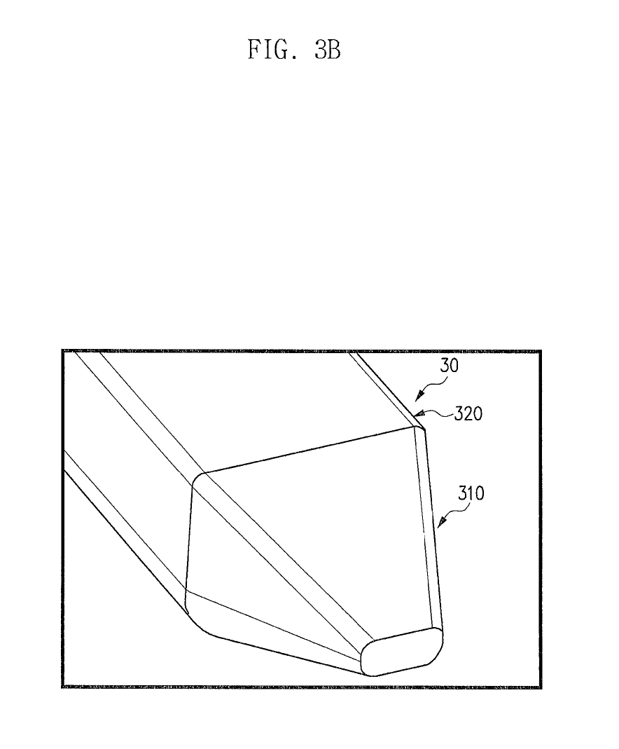

Referring to FIGS. 3A and 3B, a touch pen 30 according to the present exemplary embodiment can have a structure of a vertically asymmetrical cross-section. For example, as shown FIGS. 3A and 3B, a corner of a touch pen can be formed in a circle of a predetermined radius while having a quadrangular cross-section structure, and a radius r1 that forms a corner of an upper end portion and a radius r2 that forms a corner of a lower end portion can be differently set.

The touch pen 30 can include a pen point 310 and a penholder 320 extended from the pen point 310. The pen point 310 makes a touch on a touch screen of the terminal body and belongs to a touch input unit. The penholder 320 is connected to the pen point 310 and is a portion in which a user uses for supporting the touch pen 30 and belongs to a body.

Because a vertical corner of the penholder 320 has an asymmetrical structure having different roundness, when the user inserts the touch pen 30 into a pen receiving hole of the terminal body, the touch pen 30 can be rightly inserted with a method of corresponding a section shape of the touch pen 30 and a section shape of the pen receiving hole.

However, a case in which the user inversely inserts the touch pen 30 by rotating by 180° due to user carelessness can occur, and in this case, because a cross-section of the penholder 320 has an asymmetrical structure, the touch pen 30 may not be completely inserted, but a portion of the penholder 320 from the pen point 310 having a predetermined slope can be inserted into a pen receiving hole by the user's overpressure. In this case, a scratch can occur in the terminal body and the touch pen, and the user can suffer inconvenience due to jamming of the touch pen.

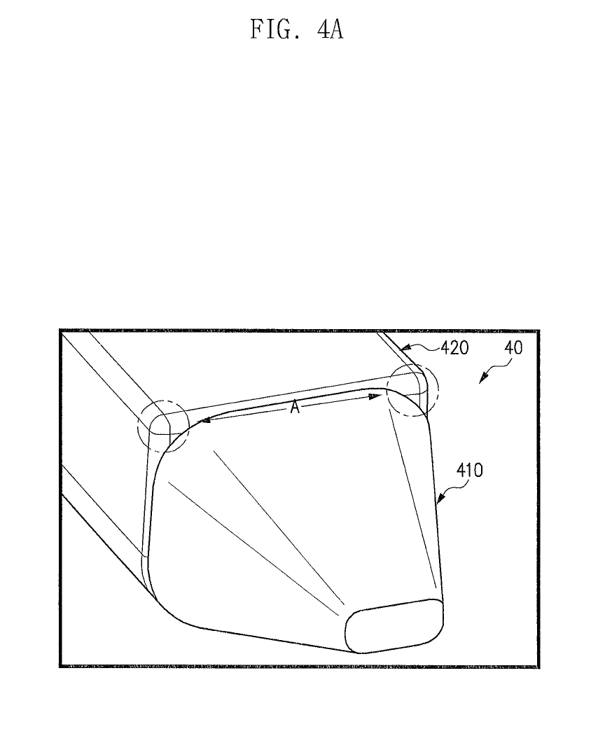

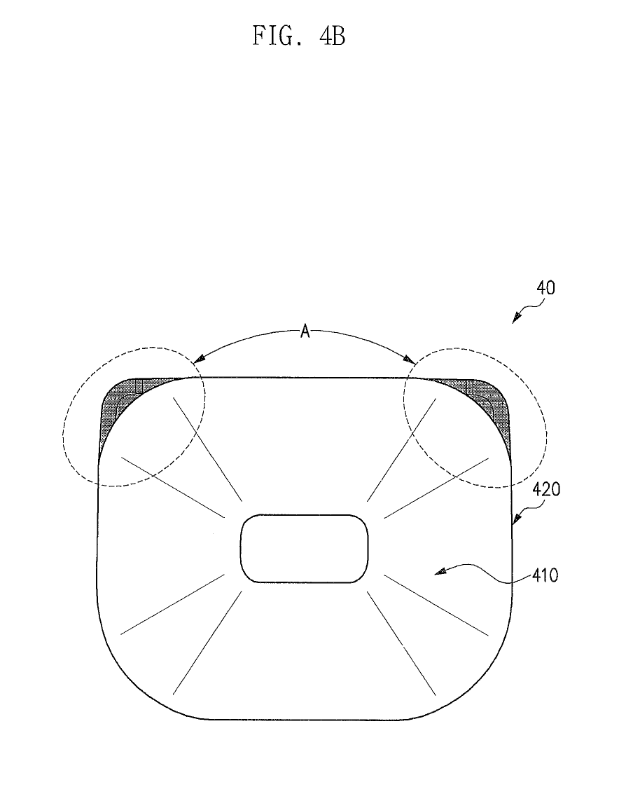

FIGS. 4A and 4B are a front view and a partial perspective view illustrating a touch input device to solve such inconvenience according to an exemplary embodiment of the present disclosure.

As shown in FIG. 4A, the touch input device according to the present exemplary embodiment can be, for example a touch pen 40. The touch pen 40 can include a pen point 410 and a penholder 420, and a protrusion A can be formed between the pen point 410 and the penholder 420. When a user pushes the touch pen 40 into the receiving hole 12, the touch pen is stopped as the protrusion contacts at least one stopper formed in the receiving hole 12. The stopper(s) is formed at a position in correspondence to that of the protrusion of the touch point.

The pen point 410 forms a touch input unit in which the touch pen 40 contacts with a touch screen or a touch pad of the terminal body and can perform a function of transferring an input signal and an instruction from the user to a mobile terminal device through a touch input. The pen point 410 can be formed with a metal material or an injection molding method and be electrically connected to a circuit or a chip mounted within the touch pen 40. The pen point 410 is formed at one end of the touch pen 40 and can have a sharp end portion to minutely contact with the touch screen. At an outer edge surface of the pen point 410, it is preferable that an insulator is coated to maintain electrical insulation from other components within the terminal body in a portion other than a portion contacting on the touch screen. The insulator can be made of a synthetic resin, a rubber material, silicon, and wood.

The penholder 420 is extended from one end of the pen point 410, forming a body of the touch pen 40, and the user can use the penholder 420 so as to support the touch pen 40. The penholder 420 can be inserted into or withdrawn from a pen receiving hole of the terminal body having an inner wall circumference formed to correspond to a shape of an outer edge circumference of the penholder 420. At an outer edge surface of the penholder 420, it is preferable that an insulator is coated to maintain electrical insulation from other components within the terminal body in a portion other than a portion contacting on the touch screen. The insulator can be made of a synthetic resin, a rubber material, silicon, and wood.

A protrusion A can be formed between the pen point 410 and the penholder 420. For example, as shown in FIGS. 4A and 4B, a protrusion A can be formed on the penholder 420 by a step between the pen point 410 and the penholder 420. Such a step can occur by different sectional areas in a portion in which each of the penholder 420 and the pen point 410 contact. For example, as shown in FIGS. 3A and 3B, in the penholder 420, roundness of an upper corner and a lower corner can be different. In this way, when an upper portion and a lower portion of the penholder 420 are asymmetrically formed and when a cross-section of the pen point 410 facing the penholder 420 is symmetrically formed, both corners of an upper portion of the penholder 420 are protruded from an outer edge circumference of the pen point 410 to form a step. When the touch pen 40 is inversely inserted into the pen receiving hole, such a step can operate as a protrusion A that disturbs insertion.

A structure of a cross-section of the pen point 410 and the penholder 420 of FIGS. 4A and 4B is an example and can be various structures such as a circle, oval, and polygon (e.g., a triangle, quadrangle, pentagon, hexagon, and octagon), and when at least one corner of the penholder 420 is protruded from an outer edge circumference of the pen point 410 to form a protrusion, the structure can correspond to the present exemplary embodiment. Therefore, a structure of a cross-section of the touch pen 40 according to the present exemplary embodiment can be a structure that prevents inverse insertion while having a desirable form structure that can enhance a user's grip feeling.

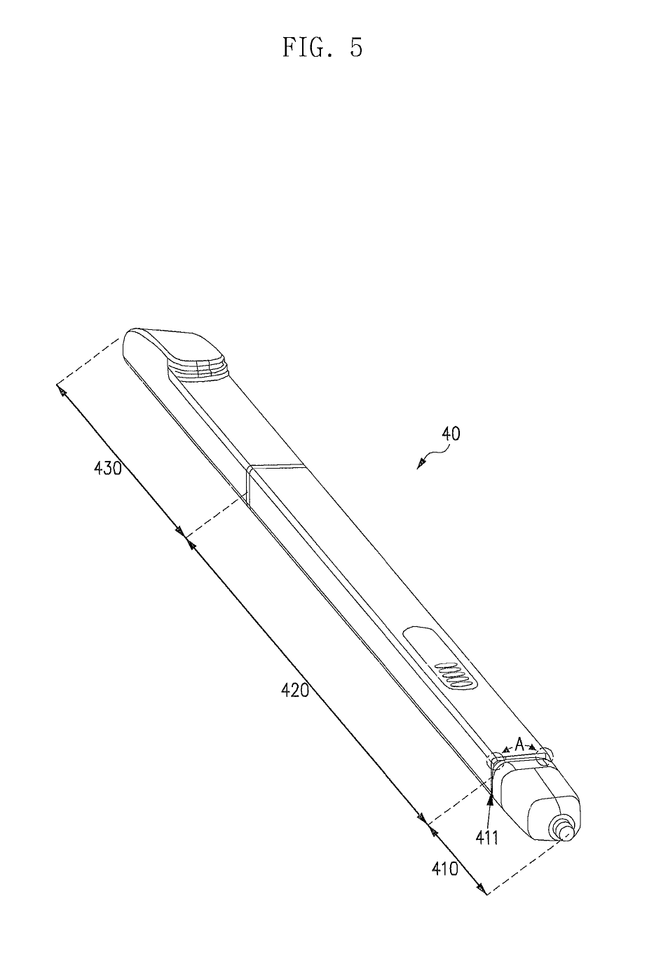

FIG. 5 is a perspective view illustrating an entire structure of a touch pen as a touch input device according to an exemplary embodiment of the present disclosure.

The touch pen 40 according to the present exemplary embodiment can include a pen point 410, a penholder 420, and an end portion 430. The pen point 410 contacts with a touch screen or a touch pad of the terminal body and can perform a function of transferring an input signal and an instruction from a user to a mobile terminal body through a touch input. The pen point 410 is formed at one end of the touch pen 40 to form a sharp end portion so as to minutely contact with the touch screen. A detailed configuration and characteristic thereof have been described with reference to FIGS. 4A and 4B.

The penholder 420 is extended from one end of the pen point 410 and can be used when the user holds the touch pen 40. The penholder 420 can further include a side button to control operation of the touch pen 40.

A protrusion A can be formed between the pen point 410 and the penholder 420. For example, a protrusion A can be formed by a step between the pen point 410 and the penholder 420.

In the pen point 410, a hole 411 can be formed along an outer edge circumference thereof. When the touch pen 40 is completely inserted into a pen receiving hole, the hole 411 can perform a function of fixing the touch pen 40 by a protruded portion complementarily formed in the pen receiving hole. Preferably, the hole 411 is connected to the protrusion A to be formed along an outer edge circumference of the pen point 410. A hole that fixes the touch pen 40 to the pen receiving hole can be formed even in the penholder 420 as well as the pen point 410 according to an exemplary embodiment.

The end portion 430 is an end portion of the touch pen 40 existing in an opposite direction of the pen point 410 and can be provided such that accessory such as a pen clip protrudes from a surface.

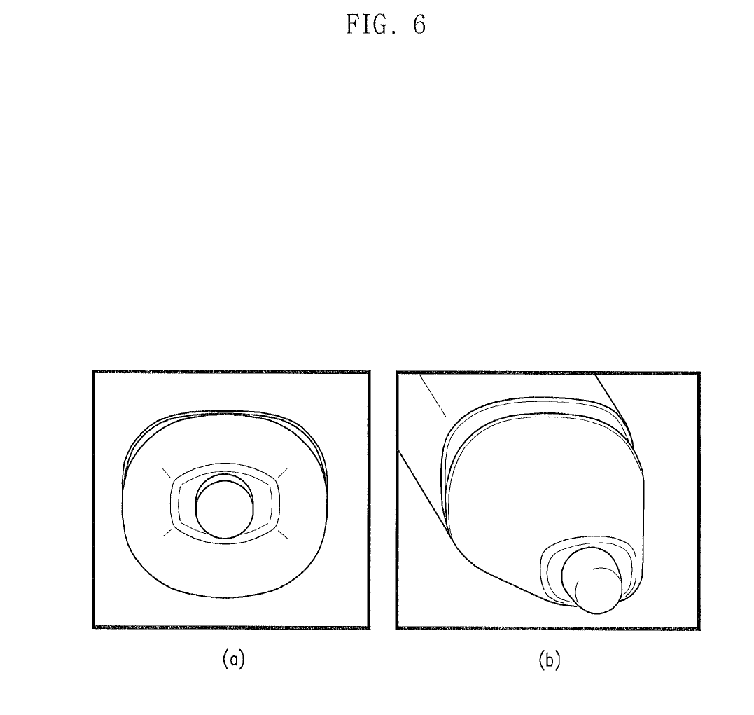

FIGS. 6A to 8B are cross-sectional views and partial perspective views illustrating touch pens according to various exemplary embodiments of the present disclosure. FIGS. 6A to 8B illustrate various exemplary embodiments of cross-sections of touch pens.

Referring to FIGS. 6A and 6B, a touch pen can have an oval cross-section structure. In this case, a portion of an outer edge circumference of the penholder, for example an upper portion of an outer edge circumference of the penholder is protruded from a pen point to form a protrusion structure. The hole is connected to the protrusion to be formed along an outer edge circumference of the pen point.

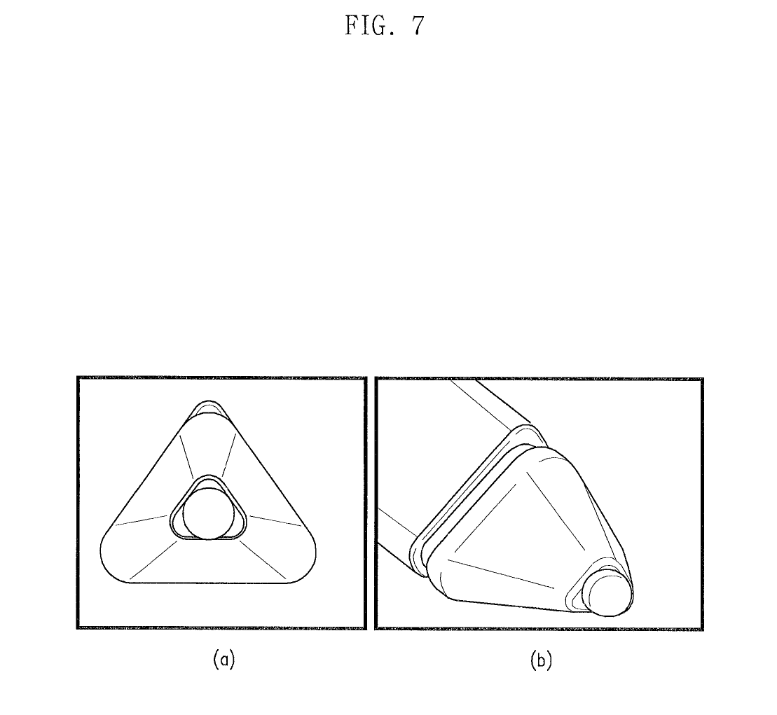

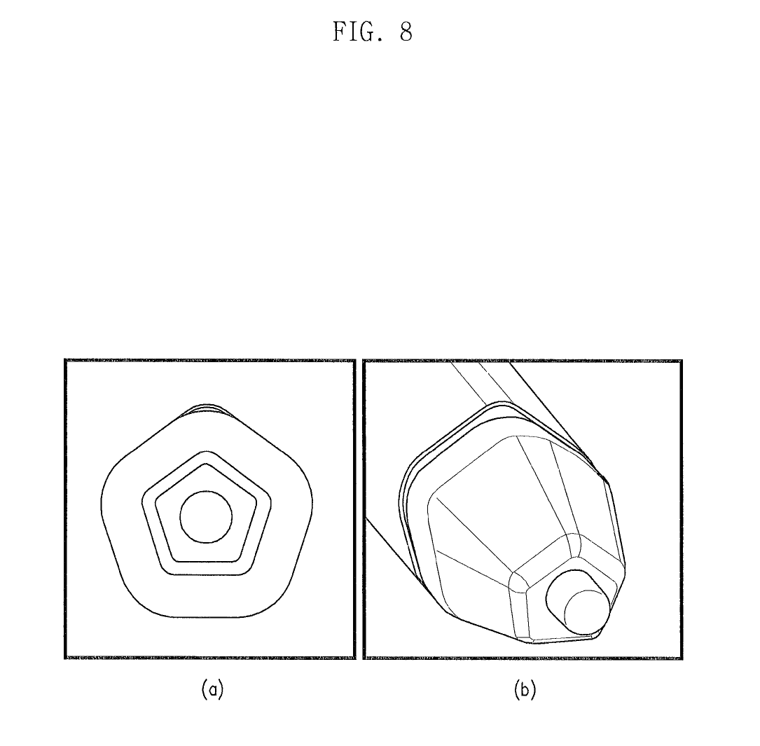

Referring to FIGS. 7A, 7B, 8A, and 8B, a touch pen can have the cross-section structures of polygons such as a triangle to a pentagon. In this case, a corner of at least one of polygons is protruded from the pen point to form a protrusion structure. A hole is connected to the protrusion to be formed along an outer edge circumference of the pen point.

When the touch pen is inversely inserted into the pen receiving hole, the generated protrusion structure can operate to disturb insertion.

As described above, according to the present exemplary embodiment, a touch pen can have various structures of a circle, oval, and polygon (e.g., a triangle, quadrangle, pentagon, hexagon, and octagon), and when at least one corner of the penholder is protruded from an outer edge circumference of the pen point to form a protrusion, the structure can correspond to the present exemplary embodiment.

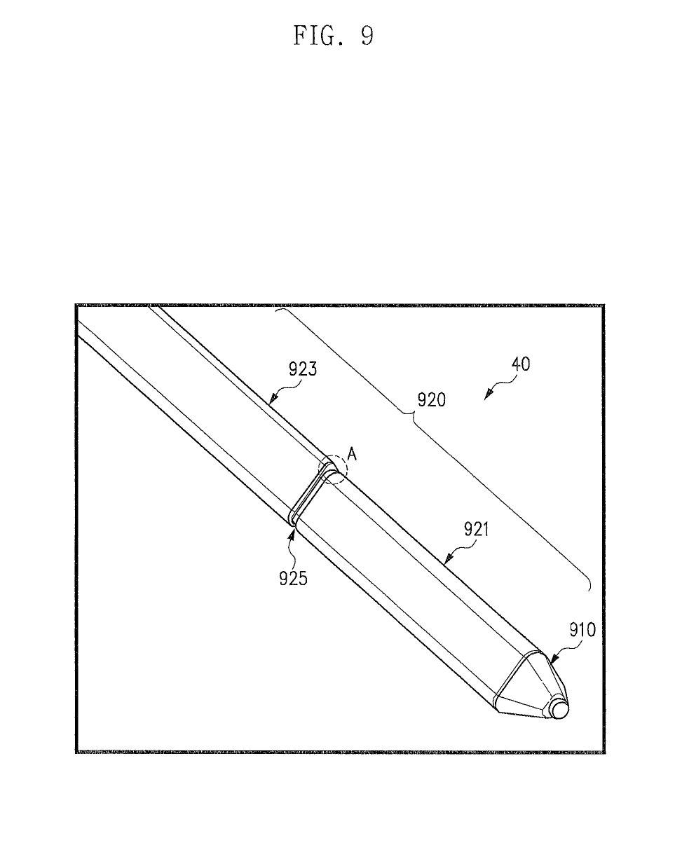

FIG. 9 is a partial perspective view illustrating a touch pen according to another exemplary embodiment of the present disclosure.

The touch pen 40 according to the present exemplary embodiment can include a pen point 910 and a penholder 920. In the touch pen 40 according to the present exemplary embodiment, a protrusion A can be formed in the penholder 920.

Specifically, the penholder 920 can be divided into a first area 921 adjacent to the pen point 910 and a second area 923 adjacent to an end portion (not shown). A protrusion A can be formed by a step between the first area 921 and the second area 923. Further, a groove 925 is connected to the protrusion A to be formed along an outer edge circumference of the first area 921. Such a groove 925 can be formed in the first area 921, as shown in FIG. 9, but can be formed in any area of the pen point 910 or the penholder 920. In FIG. 9, a cross-section of the touch pen 40 forms a triangular structure, but is not limited thereto.

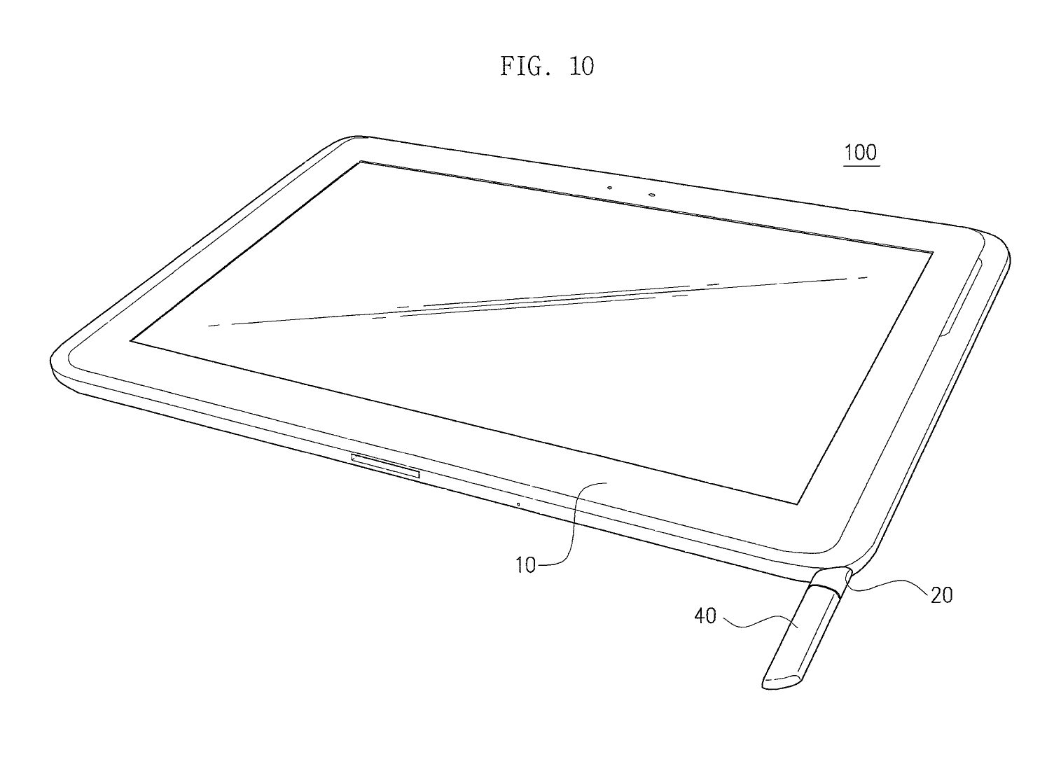

FIG. 10 is a perspective view illustrating an electronic device 100 including a touch input device, for example the touch pen 40 according to an exemplary embodiment of the present disclosure.

The mobile terminal device 100 includes a main body 10, and in the main body 10, a pen receiving hole 20 can be formed to correspond to a section of the touch pen 40 from one surface to the inside. Preferably, in order to receive the touch pen 40, the pen receiving hole 20 can have a complementary structure of the touch pen 40.

According to the present exemplary embodiment, when the touch pen 40 is erroneously inserted into the pen receiving hole 20, insertion of the touch pen 40 can be disturbed by a protrusion formed in a touch pen. Therefore, the user can recognize erroneous insertion of the touch pen 40 and rightly insert the touch pen 40.

According to the present exemplary embodiment, when the touch pen 40 is completely inserted into the pen receiving hole 20, a groove formed in the touch pen 40 and a protruded portion (not shown) complementarily formed in the pen receiving hole 20 are engaged each other and thus the touch pen 40 can be stably fixed to the pen receiving hole 20.

As described above, according to various exemplary embodiments of the present disclosure, a touch input device and an electronic device having the same can prevent damage, scratch, and loss due to erroneous insertion of the touch input device and thus user convenience can be enhanced.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A stylus pen for a touch screen device, comprising:
a body to be hand-held by a user; and
at least one protrusion formed on the body;
wherein the stylus pen is stopped by the at least one protrusion contacting at least one stopper formed in a receiving hole of the touch screen device when the stylus pen is pushed into the receiving hole.

2. The stylus pen of claim 1, wherein the body comprises a first part having a pointer and a second part, and the at least one protrusion is formed on the second part of the body.

3. The stylus pen of claim 2, wherein the at least one protrusion is formed on at least a portion of an outer edge circumference of the second part of the body.

4. The stylus pen of claim 2, wherein a cross-section of the body substantially forms a polygon, and at least one protrusion is formed on at least one corner of the polygon on the second part of the body.

5. The stylus pen of claim 2, wherein the body comprises a first part and a second part and the body has a groove between the first part and the second part.

6. The stylus pen of claim 5, wherein the receiving hole of the touch screen device has a tongue on its inside surface, to engage the groove of the stylus pen.

7. The stylus pen of claim 2, wherein a cross-section of the body substantially forms a triangular, and at least one protrusion is formed on at least one corner of the triangular.

8. The stylus pen of claim 2, wherein a cross-section of the body substantially forms a rectangular, and at least one protrusion is formed on at least one corner of the rectangular.

9. The stylus pen of claim 2, wherein a cross section of the body is substantially an oval and at least one protrusion is formed on a circumference of the oval.

10. The stylus pen of claim 2, wherein the at least one protrusion is formed on the second part by forming a sectional area of the first part to be smaller than that of the second part.

11. An electronic device, comprising:
a main body having a touch screen, wherein the main body comprises a receiving hole having at least one stopper on its inside surface; and
a stylus pen comprising:
a pen body to be hand-held by a user; and
at least one protrusion formed on the pen body,
wherein the stylus pen is stopped by the at least one protrusion contacting at least one stopper formed in the receiving hole of the main body when the stylus pen is pushed into the receiving hole.

12. The electronic device of claim 11, wherein the pen body comprises a first part having a pointer and a second part, and the at least one protrusion is formed on the second part of the pen body.

13. The electronic device of claim 12, wherein the at least one protrusion is formed on at least a portion of an outer edge circumference of the second part of the pen body.

14. The electronic device of claim 12, wherein a cross-section of the pen body substantially forms a polygon, and at least one protrusion is formed on at least one corner of the polygon on the second part of the pen body.

15. The electronic device of claim 11, wherein the pen body comprises a first part and a second part and the pen body has a groove between the first part and the second part.

16. The electronic device of claim 15, wherein the receiving hole of the main body has a tongue on its inside surface, to engage the groove of the stylus pen.

17. The electronic device of claim 11, wherein a cross-section of the pen body substantially forms a triangular, and at least one protrusion is formed on at least one corner of the triangular.

18. The electronic device of claim 11, wherein a cross-section of the pen body substantially forms a rectangular, and at least one protrusion is formed on at least one corner of the rectangular.

19. The electronic device of claim 18, wherein a cross section of the pen body is substantially an oval and at least one protrusion is formed on a circumference of the oval.

20. The electronic device of claim 11, wherein the at least one protrusion is formed on the second part by forming a sectional area of the first part to be smaller than that of the second part.
